(19) United States
(12) Patent Application Publication
(10) Pub. No.: US 2025/0329656 A1
(43) Pub. Date: Oct. 23, 2025

(54) APPARATUS, SYSTEM, AND METHOD FOR INTEGRATING PASSIVE ELEMENTS INTO ELECTRONIC BRIDGE COMPONENTS

(71) Applicant: Advanced Micro Devices, Inc., Santa Clara, CA (US)

(72) Inventors: Gabriel Hsiuwei Loh, Bellevue, WA (US); Rajasekaran Swaminathan, Austin, TX (US); Eric John Chapman, Austin, TX (US)

(73) Assignee: Advanced Micro Devices, Inc., Santa Clara, CA (US)

(21) Appl. No.: 18/088,908

(22) Filed: Dec. 27, 2022

(51) Int. Cl. H01L 23/538; H01L 21/48

(52) U.S. Cl. CPC H01L 23/5381; H01L 21/4853; H01L 23/5384; H10D 1/68

(57) ABSTRACT

A bridge device includes a bridge component including a semiconductor material. The bridge device also includes one or more routing layers of the bridge component dimensioned to electronically couple a first die and one or more second dice. Additionally, the bridge device includes one or more passive elements integrated into the bridge component and configured to store an electrical charge. Various other apparatuses, systems, and methods are also disclosed.

### BACKGROUND

In computing systems, electrical circuits can be designed on separate components, such as a die or a chip, and combined to create more complex systems. Some integrated circuits are designed to perform specific functions for a computing system, and each integrated circuit is added as a modular piece to a computing device. For example, a graphics processor chip and a memory card can be separately added to a substrate or a printed circuit board to work together as part of a display device. In some systems, electronic bridges can be coupled to dies or chiplets to connect two separated integrated circuits. For example, a silicon bridge can include its own integrated circuits that transmit electric currents and signals between dies. Each of these components can also be powered by a power source through a base substrate or other connective components.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 illustrates a detailed view of an example bridge device with exemplary integrated passive elements.

FIG. 2 illustrates a side view of an example bridge device with exemplary integrated passive elements and exemplary integrated active elements.

FIG. 3 illustrates a side view of an example system with a bridge apparatus obstructing a power supply to exemplary electronic dies.

FIG. 4 illustrates a side view of an example system using an example bridge device with exemplary integrated passive elements.

FIG. 5 illustrates a side view of an alternate example system using an example bridge device with exemplary integrated passive elements.

FIG. 6 illustrates a top view of another example system using an example bridge device with additional exemplary integrated passive elements.

FIG. 7 is a block diagram illustrating an exemplary flow of electrical charge in an example system using an example bridge device.

FIG. 8 is a flow diagram of an example method of manufacturing for integrating passive elements into electronic bridge components.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to apparatuses, systems, and methods for integrating passive elements into electronic bridge components. As described below, by connecting multiple electronic components with electronic bridges, a computing system can incorporate more components into a single device or system. For example, silicon bridges provide dense connectivity between multiple dies and chiplets. In this example, dies and chiplets are placed on a substrate that can supply power to the components, such as through vertical copper pillars. To maintain signal integrity across a die or chip, the power supply needs a certain degree of stability and reliability to deliver consistent power to the circuits.

However, the area of a die or chiplet covered by the bridge can obstruct power supply to the circuits. In other words, a silicon bridge can block power delivery to a die in the regions where the bridge interfaces to the die, creating an obstruction. The obstruction leads to less reliable local power distribution to the die and reduced circuit performance. In some examples, power can be redirected around the interfacing portion of the bridge, creating a longer distance between the power source and the die. However, the longer distance from supplying power laterally across a die, rather than through vertical pillars, can result in increased electrical resistance and less effective and less reliable power delivery. For example, the longer distance can create higher voltage drops and larger effects due to a higher rate-of-change of the current. In addition, the obstruction can also impact system performance by restricting clock speed, since higher speed contributes to less reliable power due to the potential for sudden current draws.

In other examples, larger chiplets can add more capacitors to provide additional power and/or more connections to the power source. However, the added components impact the form factor and potential performance of the system, creating a higher design overhead to ensure power delivery. In other words, additional components require more space and cost to implement. Thus, a more efficient bridge design is needed to ensure power is supplied to obstructed areas.

In some implementations, the disclosed bridge device includes integrated passive elements, such as deep-trench capacitors (DTCs), capable of storing an electrical charge. In these implementations, the stored electrical charge can then be used to power dies or chips connected to the bridge device. By maintaining and storing power in the passive elements, the bridge device can improve power supply stability to the dies. In a non-limiting example, the disclosed bridge device can include a semiconductor material, such as silicon. By integrating passive elements directly into the silicon material of a silicon bridge, the bridge device can avoid increasing the area needed to power the connected dies. In some non-limiting examples, different passive elements, such as inductors or other types of capacitors, can be integrated into the bridge. In other examples, the bridge device can be an active bridge with similar integrated elements to provide power to active elements of the bridge device as well.

Furthermore, a computing system can include a substrate that delivers electrical power to multiple components, including dies, chips, bridges, or other combinations of electronic components. By integrating passive elements like capacitors into a silicon bridge itself, the bridge can store and provide extra charge during a current draw event of a corresponding die. By storing additional power in the bridge, the area of a die or chiplet covered by the bridge can draw current from a closer location during a surge instead of relying on a longer distance power source. In other words, the passive elements improve a power network within and near a region of the chips or dies blocked by the bridge, which can also increase a local decoupling capacitance. In these examples, the passive elements provide more stable power to the computing system as a whole. Thus, the disclosed apparatus, systems, and method of manufacturing integrate passive elements into bridge devices for better power delivery.

As will be described in greater detail below, the present disclosure describes various apparatuses, systems, and methods for integrating passive elements into electronic bridge components. In one implementation, a bridge device includes a bridge component comprising a semiconductor material. The bridge device also includes one or more routing layers of the bridge component that are dimensioned to electronically couple a first die and one or more second dies. Additionally, the bridge device includes one or more passive elements integrated into the bridge component and configured to store an electrical charge.

In one example, the routing layer is disposed on a side of the bridge device facing the first die and the second die.

In one example, the bridge device can further include one or more alternative passive elements. In this example, an alternative passive element can include an integrated inductor, an integrated resistor, a transformer, a diode, and/or a fuse.

In one example, the passive element configured to store the electrical charge includes an integrated capacitor. In this example, the integrated capacitor provides the stored electrical charge, via an integrated circuit drawing a current, to the first die, the second die, and/or a different element integrated into the bridge component.

In one example, the passive element can be positioned on the bridge device to provide the stored electrical charge to an area of the first die overlapping the bridge device and/or an area of the second die overlapping the bridge device. In this example, the passive element can be configured to increase a decoupling capacitance in an area of the bridge device around the passive element and the area of the first die overlapping the bridge device and/or the area of the second die overlapping the bridge device. In this example, a second passive element can be integrated into the bridge component and configured to store the electrical charge, wherein the second passive element is positioned on the bridge device between the area of the first die overlapping the bridge device and the area of the second die overlapping the bridge device.

In one example, the bridge device can include a passive bridge and/or an active bridge. In this example, the passive element of the active bridge can be configured to provide the stored electrical charge to one or more active elements of the active bridge.

In one example, the bridge device can further include one or more through-silicon vias (TSVs) embedded in the bridge component such that a TSV conducts the electrical charge through one or more layers of the bridge device.

In one implementation, a system includes a first die comprising a first integrated circuit in a semiconductor material. The system also includes one or more second dies comprising one or more second integrated circuits in the semiconductor material and disposed within a distance of the first die. Additionally, the system includes one or more substrates coupled to the first die and a second die such that a substrate delivers an electrical charge to the first die and the second die. Furthermore, the system includes one or more bridge devices dimensioned to span the distance and electronically couple the first die and the second die, wherein one or more passive elements are integrated into a bridge device to store the electrical charge.

In one example, the substrate is coupled to the first die and the second die at a metal layer of the first die and a metal layer of the second die.

In one example, a passive element is positioned on the bridge device based on the first integrated circuit of the first die. Additionally or alternatively, a passive element is positioned on the bridge device based on a second integrated circuit of the second die.

In one example, the bridge device is electronically coupled to the first die and the second die such that the bridge device overlaps an area of the first die and an area of the second die. In this example, the area of the first die overlapping the bridge device draws a current from the substrate laterally across the first die and/or the electrical charge stored by the passive element of the bridge device during a draw event of the first die. In this example, the area of the second die overlapping the bridge device draws a current from the substrate laterally across the second die and/or the electrical charge stored by the passive element of the bridge device during a draw event of the second die.

In one implementation, a method of manufacturing includes coupling a first die to one or more substrates such that a substrate delivers an electrical charge to the first die. The method of manufacturing also includes coupling a second die to the substrate such that the substrate delivers the electrical charge to the second die. The method of manufacturing then includes integrating one or more passive elements into a bridge device, wherein a passive element is configured to store the electrical charge. Finally, the method of manufacturing includes electronically coupling the bridge device to the first die and the second die such that the passive element is electronically coupled to the first die and/or the second die.

In one example, electronically coupling the bridge device to the first die and the second die includes electronically coupling a routing layer of the bridge device to a metal layer of the first die, a metal layer of the second die, a different layer of the first die, and/or a different layer of the second die.

Features from any of the implementations described herein can be used in combination with one another in accordance with the general principles described herein. These and other implementations, features, and advantages will be more fully understood upon reading the following detailed description in conjunction with the accompanying drawings and claims.

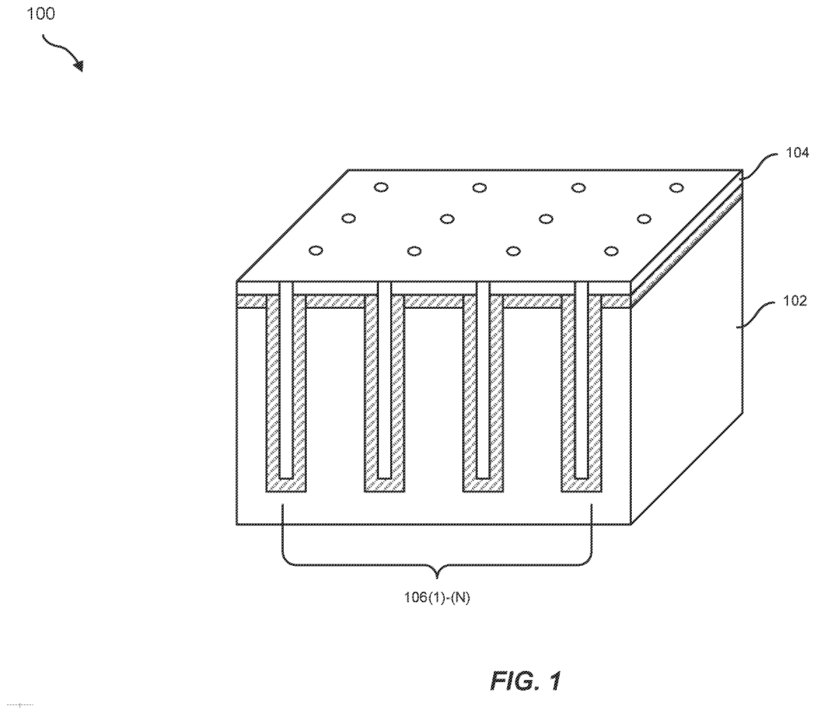

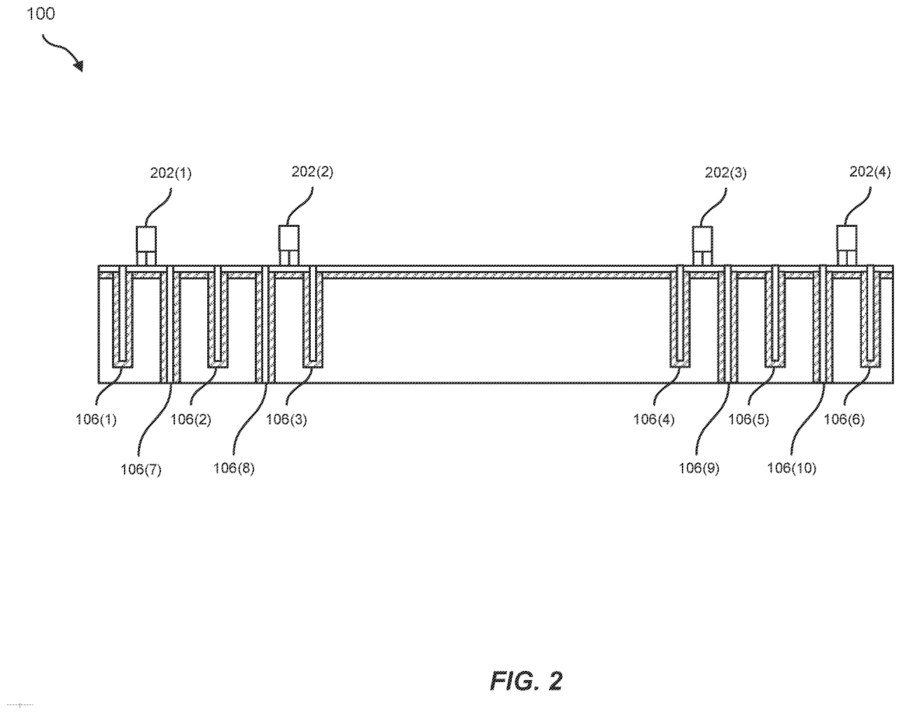

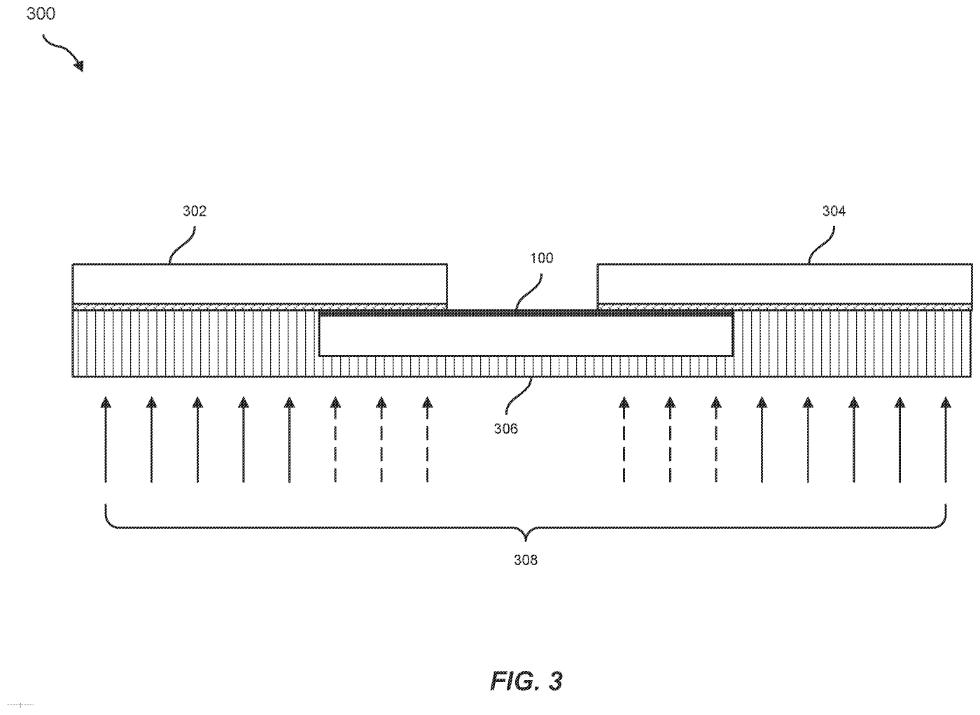

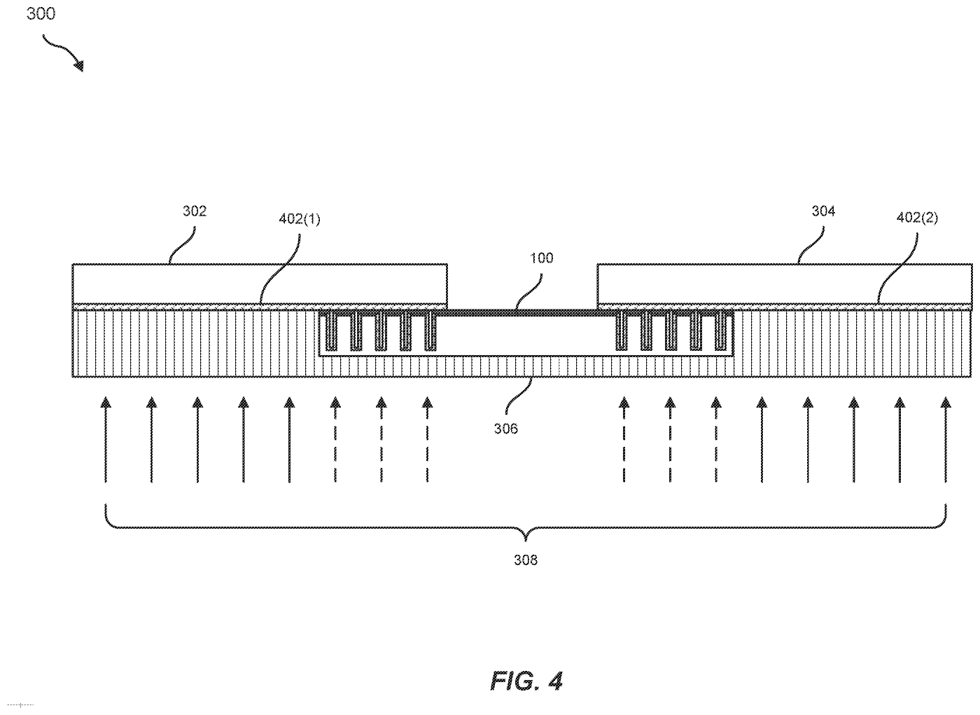

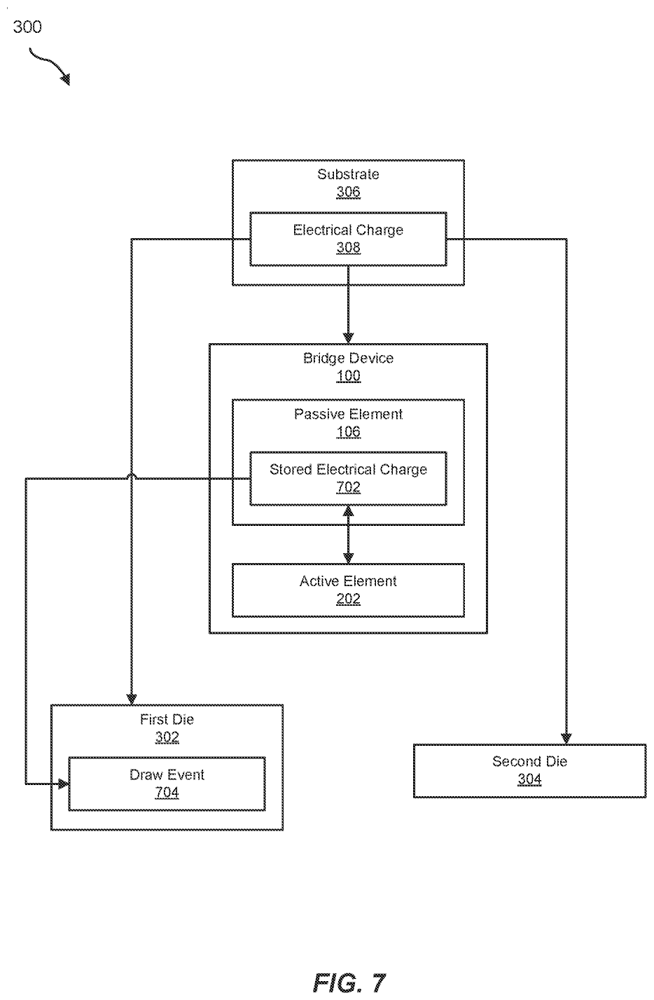

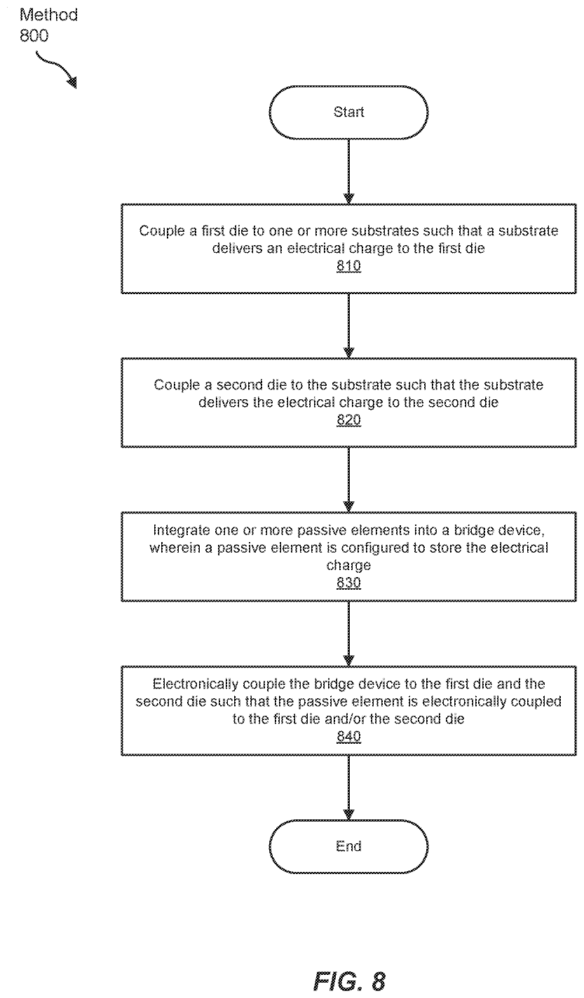

The following will provide, with reference to FIGS. 1-2, detailed descriptions of example apparatuses for integrating passive elements into electronic bridge components. Detailed descriptions of a system with a bridge apparatus obstructing a power supply to electronic dies will be provided in connection with FIG. 3. In addition, detailed descriptions of systems using bridges with integrated passive elements will be provided in connection with FIGS. 4-6. Furthermore, detailed descriptions of a flow of electrical charge will be provided in connection with FIG. 7. Detailed descriptions of exemplary methods of manufacturing bridge devices with integrated passive elements will also be provided in connection with FIG. 8.

FIG. 1 illustrates a detailed view of an example bridge device 100 with exemplary integrated passive elements 106(1)-(N). In non-limiting examples, the term “bridge” refers to an electronic component capable of electronically coupling two other electronic components. Examples of bridges include, without limitation, Elevated Fanout Bridges (EFBs), Embedded Multi-Die Interconnect Bridges (EMIBs), silicon bridges, and/or any other type or form of connective bridge components. In the example of FIG. 1, bridge device 100 includes a bridge component 102 comprising a semiconductor material, such as silicon. In some examples, bridge component 102 comprises a rigid material holding a specific form. In some examples, the semiconductor material includes one or more portions acting as an insulator and one or more portions acting as a conductor.

In the example of FIG. 1, bridge device 100 includes a routing layer 104 of bridge component 102 dimensioned to electronically couple a first die and one or more second die. For example, bridge device 100 can be a silicon bridge that provides electronic connectivity between the first die and a second die through routing layer 104. In this example, routing layer 104 can include an integrated circuit designed into the silicon material of bridge device 100. In non-limiting examples, the terms “die” and “chip” refer to a modular block containing an integrated circuit. In these examples, the term “integrated circuit” refers to an electronic circuit directly integrated and/or etched into an electronic component. Example of dies or chips include, without limitation, system-on-chips (SOCs), graphic processing units (GPUs), central processing units (CPUs), high-bandwidth memory (HBM) stacks, interface circuits, Serializer/Deserializer (SerDes) blocks, semiconductor chips, and/or any other suitable modular components with integrated circuits.

Additionally, bridge device 100 includes passive elements 106(1)-(N) integrated into bridge component 102. In some examples, one or more of passive elements 106(1)-(N) is configured to store an electrical charge. In non-limiting examples, the term “passive element” refers to an electronic component that can receive electricity and that does not actively switch external power or a current. Examples of passive elements include, without limitation, deep-trench capacitors (DTCs), inductors, resistors, metal-insulator-metal capacitors (MIM Caps), airgap capacitors, through-silicon vias (TSVs), and/or any other suitable passive components. In the example of FIG. 1, passive elements 106(1)-(N) can include integrated capacitors that store the electrical charge and/or alternative types of passive elements, such as integrated inductors and/or integrated resistors, that perform other functions like regulating electrical current. Furthermore, bridge device 100 of FIG. 1 represents a passive bridge. In non-limiting examples, the term “passive bridge” refers to a bridge with only passive elements and/or that does not actively switch external power or a current.

FIG. 2 illustrates a side view of a different bridge device 100 with integrated passive elements 106(1)-(10) and integrated active elements 202(1)-(4). In contrast to FIG. 1, bridge device 100 of FIG. 2 represents an active bridge. In non-limiting examples, the term “active bridge” refers to a bridge with active elements that require electricity to function. In non-limiting examples, the term “active element” refers to an electronic component that can control electricity and that needs external power to function. Examples of active elements include, without limitation, computing devices, transistors, and/or any other type of active component.

In some examples, passive elements 106(1)-(6) of the active bridge are configured to provide the stored electrical charge to active elements 202(1)-(4), such as transistors. In further examples, bridge device 100 includes one or more through-silicon vias (TSVs) embedded in bridge component 102 such that a TSV conducts the electrical charge through one or more layers of bridge device 100. In the example of FIG. 2, passive elements 106(7)-(10) can represent embedded TSVs that enable power delivery directly through bridge device 100. In this example, vias such as TSVs can include a conductive material, such as copper, to more easily transmit electricity.

Additionally, other examples of bridge device 100 can integrate different types of passive elements, combinations of different passive elements, and/or different combinations of passive and active elements. For passive bridges, the passive elements provide the stored electrical charge to dies coupled to the bridge as needed. For active bridges, the passive elements provide the stored electrical charge to the dies and/or to active elements of the bridge.

FIG. 3 illustrates a side view of an example system 300 with bridge device 100 obstructing a power supply of an electrical charge 308 to a first die 302 and a second die 304. System 300 generally represents any type or form of computing system or computing device with electronic components to perform computing functions. Examples of system 300 include, without limitation, chiplets, printed circuit boards (PCBs), processors, and/or other electronic components or combinations of the same. Additional examples of system 300 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, servers, variations or combinations of one or more of the same, a portion of one or more of the same, or any other suitable computing device.

Many other devices or subsystems can be connected to system 300 in FIGS. 3-7. Conversely, all of the components and devices illustrated in FIGS. 3-7 need not be present to practice the implementations described and/or illustrated herein. The devices and subsystems referenced above can also be interconnected in different ways from that shown in FIGS. 3-7. System 300 can also employ any number of software, firmware, and/or hardware configurations.

In the example of FIG. 3, system 300 includes first die 302, which includes a first integrated circuit in a semiconductor material, and second die 304, which includes a second integrated circuit in the semiconductor material and is disposed within a distance of first die 302. For example, first die 302 and second die 304 can both be silicon dies with integrated circuits etched into the silicon material. In the example of FIG. 3, system 300 also includes a substrate 306 coupled to first die 302 and second die 304 such that substrate 306 delivers electrical charge 308 to first die 302 and second die 304. In this example, system 300 further includes bridge device 100 dimensioned to span the distance between and electronically couple first die 302 and second die 304. However, in this example, bridge device 100 obstructs electrical charge 308 from an area of first die 302 overlapping bridge device 100 and an area of second die 304 overlapping bridge device 100, as illustrated by the dotted arrows. In this example, bridge device 100 does not include passive elements 106(1)-(N) of FIG. 1.

FIG. 4 illustrates a side view of system 300 using bridge device 100 with integrated passive elements 106(1)-(N) of FIG. 1. In the example of FIG. 4, passive elements 106(1)-(N) are integrated into bridge device 100 to store electrical charge 308. In this example, routing layer 104 of FIG. 1 is disposed on a side of bridge device 100 facing first die 302 and second die 304, thus providing connectivity between first die 302 and second die 304. Additionally, passive elements 106(1)-(N) are positioned on bridge device 100 to store electrical charge 308 and provide stored electrical charge 308 to the area of first die 302 overlapping bridge device 100 and/or the area of second die 304 overlapping bridge device 100. In other words, passive elements 106(1)-(N) are positioned where bridge device 100 obstructs the power supply, as shown by the dotted arrows.

In the example of FIG. 4, substrate 306 is coupled to first die 302 and second die 304 at a metal layer 402(1) of first die 302 and a metal layer 402(2) of second die 304. In this example, routing layer 104 of bridge device 100 is also coupled to metal layers 402(1)-(2). In some examples, bridge device 100 is electronically coupled to first die 302 and second die 304 such that bridge device 100 overlaps an area of first die 302 and an area of second die 304. In these example, the area of first die 302 overlapping bridge device 100 draws a current from substrate 306 laterally across first die 302 and/or from electrical charge 308 stored by passive elements 106(1)-(N) of bridge device 100. Similarly, the area of second die 304 overlapping bridge device 100 draws a current from substrate 306 laterally across second die 304 and/or from electrical charge 308 stored by passive elements 106(1)-(N) of bridge device 100.

In the above examples, drawing the current laterally across first die 302 and/or second die 304 increases a delay and/or a voltage drop of power to the overlapping areas. In contrast, drawing the current from electricity stored in passive elements 106(1)-(N) provides a closer power source with less delay and/or less voltage drop. In other words, integrating passive elements, such as capacitors, provides extra charge at a local source to reduce the impact of distance. Additionally, bridge device 100 of FIG. 2 can include TSVs such that the overlapping areas of first die 302 and/or second die 304 directly draw power through bridge device 100 through the TSVs, thereby decreasing the distance in comparison to drawing the current laterally across first die 302 and/or second die 304 and supplementing the power from the local source of passive elements 106(1)-(N).

In some examples, passive elements 106(1)-(N) are configured to increase a decoupling capacitance in an area of bridge device 100 around each of passive elements 106(1)-(N) and the area of first die 302 overlapping bridge device 100 and/or the area of second die 304 overlapping bridge device 100. In non-limiting examples, the term “decoupling capacitance” refers to an ability of a decoupling capacitor to store a charge. In these examples, the term “decoupling capacitor” refers to a capacitor used to decouple or separate parts of a circuit. For example, DTCs can provide additional local decoupling capacitance such that the overlapping areas of first die 302 and second die 304 draw a charge from the DTCs without affecting a global supply source, thereby improving an overall power supply stability during a sudden power draw.

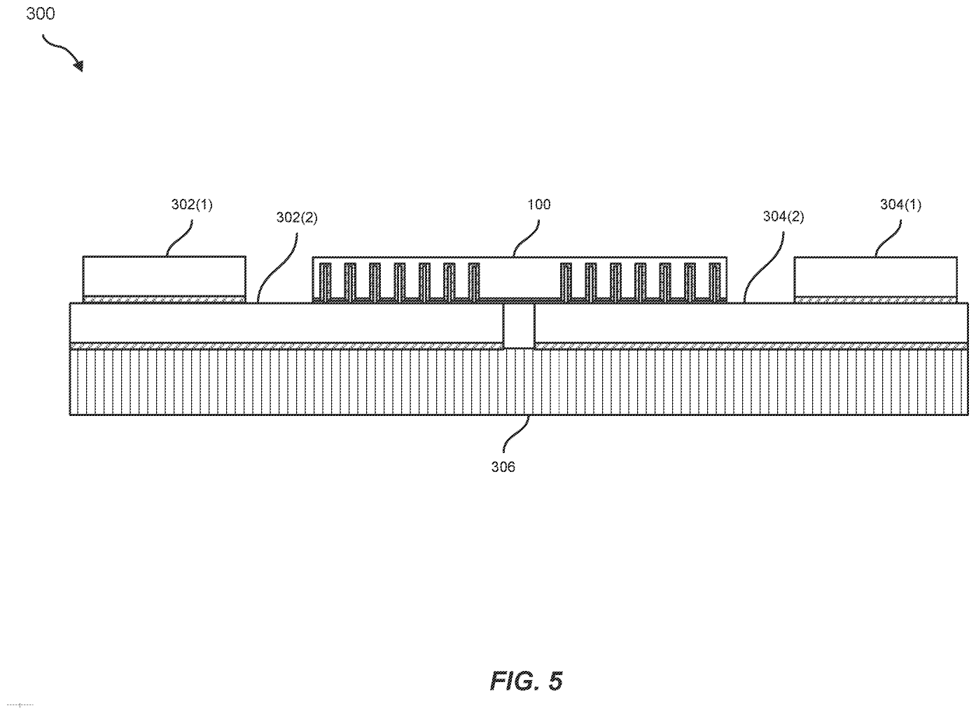

FIG. 5 illustrates a side view of an alternate system 300 using bridge device 100 with integrated passive elements 106(1)-(N). In the example of FIG. 5, first dies 302(1)-(2) can represent a first chiplet, and second dies 304(1)-(2) can represent a second chiplet. As shown in the example of FIG. 5, bridge device 100 can be coupled to first die 302(2), which is also coupled to first die 302(1), and second die 304(2), which is also coupled to second die 304(1), from the top rather than from the bottom as when integrated with substrate 306. In this example, routing layer 104 of bridge device 100 is coupled to different layers of first die 302(2) and second die 304(2), rather than metal layers 402(1)-(2) of FIG. 4.

Although bridge device 100 of FIG. 5 does not directly obstruct electrical charge 308, passive elements 106(1)-(N) continue to provide additional decoupling capacitance to improve a quality of power delivery from the power network to first die 302(2) and second die 304(2). For example, for sensitive high-speed chip-to-chip circuits, the placement of bridge device 100 can improve overall power stability. Alternatively, bridge device 100 can be placed in other configurations according to the different needs and configurations of various dies and chiplets of system 300.

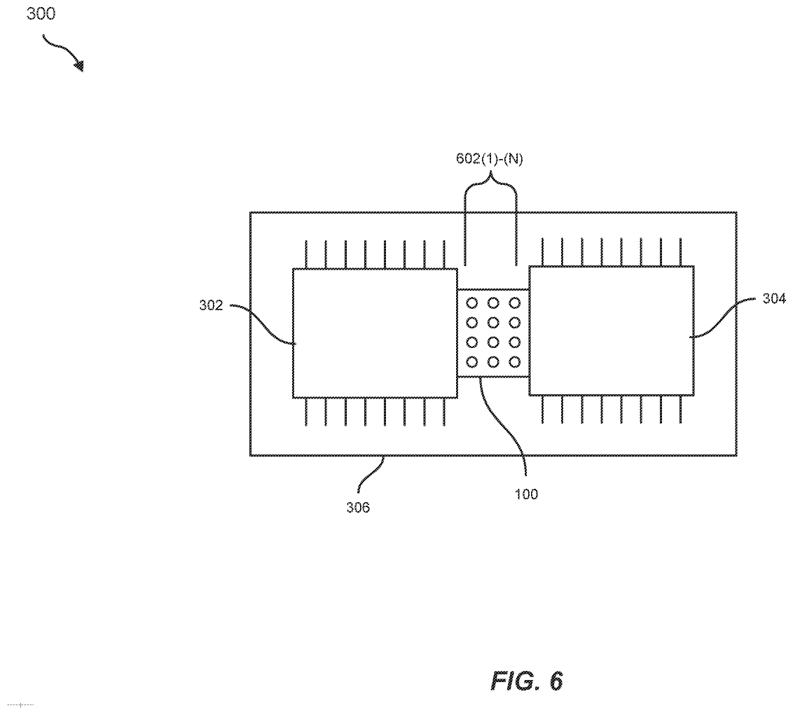

FIG. 6 illustrates a top view of system 300 using bridge device 100 with additional integrated second passive elements 602(1)-(N). In some examples, passive elements 106(1)-(N) of FIG. 1 are positioned on bridge device 100 based on the first integrated circuit of first die 302 and/or the second integrated circuit of second die 304. In the example of FIG. 6, bridge device 100 includes second passive elements 602(1)-(N) integrated into bridge component 102 and configured to store electrical charge 308. In this example, second passive elements 602(1)-(N) are positioned on bridge device 100 between the area of first die 302 overlapping bridge device 100 and the area of second die 304 overlapping bridge device 100. In other words, bridge device 100 can include additional passive elements to add local decoupling capacitance to first die 302 and/or second die 304 beyond the overlapping areas. In this example, the additional decoupling capacitance due to second passive elements 602(1)-(N) can also improve power stability for an active bridge. In other examples, system 300 can include alternative configurations with additional or fewer components compared to those illustrated in FIGS. 4-6.

FIG. 7 is a block diagram illustrating an exemplary flow of electrical charge 308 in system 300 that uses bridge device 100. As shown in FIG. 7, substrate 306 provides electrical charge 308 to first die 302, second die 304, and bridge device 100. In addition, a passive element 106 of bridge device 100 retains a stored electrical charge 702 from electrical charge 308. In this example, an active element 202 can draw power from stored electrical charge 702 of passive element 106.

In some examples, passive element 106 represents an alternative passive element, such as an integrated inductor, an integrated resistor, a transformer, a diode, a fuse, and/or any type of passive element that does not store an electrical charge. In these examples, the alternative passive element, such as an integrated inductor or an integrated resistor, can regulate a current of electrical charge 308 and/or stored electrical charge 702. In other examples, passive element 106 represents an integrated capacitor or other type of passive element that can store an electrical charge. In these examples, the integrated capacitor provides stored electrical charge 702, via an integrated circuit of bridge device 100 drawing a current, to first die 302, second die 304, and/or a different element integrated into bridge device 100, such as active element 202. In some examples, active element 202 can further regulate or control electrical charge 308 and/or stored electrical charge 702.

In the example of FIG. 7, the area of first die 302 overlapping bridge device 100 draws a current from stored electrical charge 702 stored by passive element 106 of bridge device 100 during a draw event 704 of first die 302. In non-limiting examples, the term “draw event” refers to a computing event during which an amount of electricity or current is drawn from a power source, such as during a power surge. By drawing power from stored electrical charge 702 during draw event 704, the overlapping area of first die 302 can increase power stability and speed by supplementing any power drawn from substrate 306, which then reduces the impact of draw event 704 on a global power supply of system 300. In other examples, second die 304 can similarly draw from stored electrical charge 702 during a draw event.

FIG. 8 shows an example method for manufacturing, assembling, using, adjusting, or otherwise configuring or creating the systems and apparatuses presented herein. The steps shown in FIG. 8 can be performed by any individual and/or by any suitable type or form of manual and/or automated apparatus. In particular, FIG. 8 illustrates a flow diagram of an exemplary method 800 for manufacturing bridge devices.

As shown in FIG. 8, at step 810, one or more of the systems described herein can couple a first die to one or more substrates such that a substrate delivers an electrical charge to the first die. For example, as illustrated in FIG. 4, first die 302 is coupled to substrate 306 such that substrate 306 delivers electrical charge 308 to first die 302.

The systems described herein can perform step 810 in a variety of ways. As shown in FIG. 4, first die 302 can be coupled to a top surface of substrate 306, and substrate 306 can include conductive material, such as vertical copper pillars, to deliver electrical charge 308 to first die 302 from a power source. In the example of FIG. 5, first die 302(2) is coupled to substrate 306, which delivers electrical charge 308 to first die 302(2). In this example, first die 302(1) is coupled to first die 302(2) such that electrical charge 308 is then delivered from first die 302(2) to first die 302(1). In other examples, different configurations of dies or chips can be combined as part of first die 302 and powered by substrate 306.

Returning to FIG. 8, at step 820, one or more of the systems described herein can couple a second die to the substrate such that the substrate delivers the electrical charge to the second die. For example, as illustrated in FIG. 4, second die 304 is coupled to substrate 306 such that substrate 306 delivers electrical charge 308 to second die 304.

The systems described herein can perform step 820 of FIG. 8 in a variety of ways. In the example of FIG. 4, second die 304 can be coupled to the top surface of substrate 306, and substrate 306 can deliver electrical charge 308 to second die 304 from the power source. In the example of FIG. 5, second die 304(2) is coupled to substrate 306, which delivers electrical charge 308 to second die 304(2). In this example, second die 304(1) is coupled to second die 304(2) such that electrical charge 308 is then delivered from second die 304(2) to second die 304(1). In other examples, similar to first die 302, different configurations of dies or chips can be combined as part of second die 304 and powered by substrate 306.

Returning to FIG. 8, at step 830, one or more of the systems described herein can integrate one or more passive elements into a bridge device, wherein a passive element is configured to store the electrical charge. For example, as illustrated in FIG. 1, passive elements 106(1)-(N) are integrated into bridge device 100, wherein passive elements 106(1)-(N) are configured to store electrical charge 308 of FIG. 4.

The systems described herein can perform step 830 of FIG. 8 in a variety of ways. In some examples, passive elements such as DTCs can be etched into the silicon material of bridge device 100. In these examples, a deep trench is etched into a silicon substrate of bridge device 100, and a dielectric layer is integrated into the deep trench. In the example of FIG. 2, passive elements 106(1)-(10) are positioned at the two ends of bridge device 100 based on an expected pairing with dies at the ends. Additionally, a density of the spacing between passive elements can be adjusted based on a need of system 300 and/or bridge device 100, such as by integrating fewer passive elements for simpler die designs or more and denser passive elements for an active bridge.

Returning to FIG. 8, at step 840, one or more of the systems described herein can electronically couple the bridge device to the first die and the second die such that the passive element is electronically coupled to the first die and/or the second die. For example, as illustrated in FIG. 4, bridge device 100 is electronically coupled to first die 302 and second die 304 such that passive elements 106(1)-(N) of FIG. 1 are electronically coupled to first die 302 and second die 304.

The systems described herein can perform step 840 of FIG. 8 in a variety of ways. In the example of FIG. 4, passive elements 106(1)-(N) of bridge device 100 are positioned where first die 302 and second die 304 couple to bridge device 100. Thus, in this example, passive elements 106(1)-(N) are in direct contact with metal layers 402(1)-(2) of first die 302 and second die 304, thereby electronically coupling to first die 302 and second die 304. In the example of FIG. 4, electronically coupling bridge device 100 to first die 302 and second die 304 includes electronically coupling routing layer 104 of bridge device 100 to metal layer 402(1) of first die 302 and/or metal layer 402(2) of second die 304. In the example of FIG. 5, electronically coupling bridge device 100 to first die 302 and second die 304 includes electronically coupling routing layer 104 of bridge device 100 to a different layer, such as the opposite surface, of first die 302, and/or a different layer of second die 304. Based on the design of electrical routes and/or circuitry of first die 302 and second die 304, the placement of passive elements 106(1)-(N) in bridge device 100 can be altered to fit the coupling of bridge device 100 with first die 302 and second die 304. Alternatively, the designs of first die 302 and/or second die 304 can be altered based on the placement of passive elements 106(1)-(N) in bridge device 100.

As described above, the disclosed apparatuses, systems, and methods integrate passive elements into bridge devices to provide more stable power. Accordingly, the implementations and systems described herein integrate at least one passive element into a bridge component, such as a silicon substrate. The disclosed bridge device also includes at least one routing layer that electronically couples a first die and one or more second dies. The computing system disclosed herein includes a substrate that supplies power to the first die, a second die, and the bridge device. The passive element of the bridge device then stores an electrical charge from the substrate of the system, and the first die and/or a second die can subsequently draw a current from the stored electrical charge of the passive element, particularly during a draw event. Additionally, the bridge device can include one or more active elements that also draw a current from the stored electrical charge of the passive element. Furthermore, additional passive or active elements can be integrated into the bridge device based on the design and circuitry of the first die, the design and circuitry of the second die, active elements of the bridge device, and/or other components of the system. Thus, the disclosed system and bridge device can deliver faster and more stable power to areas of dies obstructed by an electronic bridge device.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 300 in FIGS. 4-6 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In some examples, all or a portion of example system 300 in FIGS. 4-6 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A bridge device comprising:
a bridge component comprising a semiconductor material;
at least one routing layer of the bridge component dimensioned to electronically couple a first die and at least one second die; and
at least one passive element integrated into the bridge component and configured to store an electrical charge.

2. The bridge device of claim 1, wherein the routing layer is disposed on a side of the bridge device facing the first die and the second die.

3. The bridge device of claim 1, further comprising at least one alternative passive element.

4. The bridge device of claim 3, wherein the alternative passive element comprises at least one of:
an integrated inductor;
an integrated resistor;
a transformer;
a diode; or
a fuse.

5. The bridge device of claim 1, wherein the passive element configured to store the electrical charge comprises an integrated capacitor.

6. The bridge device of claim 5, wherein the integrated capacitor provides the stored electrical charge, via an integrated circuit drawing a current, to at least one of:
the first die;
the second die; or
a different element integrated into the bridge component.

7. The bridge device of claim 1, wherein the passive element is positioned on the bridge device to provide the stored electrical charge to at least one of:
an area of the first die overlapping the bridge device; or
an area of the second die overlapping the bridge device.

8. The bridge device of claim 7, wherein the passive element is configured to increase a decoupling capacitance in an area of the bridge device around the passive element and at least one of:
the area of the first die overlapping the bridge device; or
the area of the second die overlapping the bridge device.

9. The bridge device of claim 7, further comprising a second passive element integrated into the bridge component and configured to store the electrical charge, wherein the second passive element is positioned on the bridge device between the area of the first die overlapping the bridge device and the area of the second die overlapping the bridge device.

10. The bridge device of claim 1, wherein the bridge device comprises at least one of:
a passive bridge; or
an active bridge.

11. The bridge device of claim 10, wherein the passive element of the active bridge is configured to provide the stored electrical charge to at least one active element of the active bridge.

12. The bridge device of claim 1, further comprising at least one through-silicon via (TSV) embedded in the bridge component such that the TSV conducts the electrical charge through at least one layer of the bridge device.

13. A system comprising:
a first die comprising a first integrated circuit in a semiconductor material;
at least one second die comprising a second integrated circuit in the semiconductor material and disposed within a distance of the first die;
at least one substrate coupled to the first die and the second die such that the substrate delivers an electrical charge to the first die and the second die; and
at least one bridge device dimensioned to span the distance and electronically couple the first die and the second die, wherein at least one passive element is integrated into the bridge device to store the electrical charge.

14. The system of claim 13, wherein the substrate is coupled to the first die and the second die at a metal layer of the first die and a metal layer of the second die.

15. The system of claim 13, wherein the passive element is positioned on the bridge device based on at least one of:
the first integrated circuit of the first die; or
the second integrated circuit of the second die.

16. The system of claim 13, wherein the bridge device is electronically coupled to the first die and the second die such that the bridge device overlaps an area of the first die and an area of the second die.

17. The system of claim 16, wherein the area of the first die overlapping the bridge device draws a current from at least one of:
the substrate laterally across the first die; or
the electrical charge stored by the passive element of the bridge device during a draw event of the first die.

18. The system of claim 16, wherein the area of the second die overlapping the bridge device draws a current from at least one of:
the substrate laterally across the second die; or
the electrical charge stored by the passive element of the bridge device during a draw event of the second die.

19. A method of manufacturing comprising:
coupling a first die to at least one substrate such that the substrate delivers an electrical charge to the first die;
coupling a second die to the substrate such that the substrate delivers the electrical charge to the second die;
integrating at least one passive element into a bridge device, wherein the passive element is configured to store the electrical charge; and
electronically coupling the bridge device to the first die and the second die such that the passive element is electronically coupled to at least one of:
the first die; or
the second die.

20. The method of manufacturing of claim 19, wherein electronically coupling the bridge device to the first die and the second die comprises electronically coupling a routing layer of the bridge device to at least one of:
a metal layer of the first die;
a metal layer of the second die;
a different layer of the first die; or
a different layer of the second die.
